(19) United States
(12) Patent Application Publication
(10) Pub. No.: US 2008/0248834 A1
(43) Pub. Date: Oct. 9, 2008

(54) SYSTEM AND METHODS FOR PROVIDING ACCESS TO A DESKTOP AND APPLICATIONS OF A MOBILE DEVICE

(75) Inventors: Manjirnath Chatterjee, San Francisco, CA (US); Gregory R. Simon, San Francisco, CA (US); Roderick Swift, Walnut Creek, CA (US)

Correspondence Address: KACVINSKY LLC;C/O INTELLEVATE, P.O. BOX 52050, MINNEAPOLIS, MN, 55402, US

(73) Assignee: PALM, INC., SUNNYVALE, CA (US)

(21) Appl. No.: 12/061,179

(22) Filed: Apr. 2, 2008

Related U.S. Application Data
(60) Provisional application No. 60/909,719, filed on Apr. 3, 2007.

(51) Int. Cl. H04B 1/38

(52) U.S. Cl. 455/557

(57) ABSTRACT

Various embodiments are described for providing a terminal with access to a desktop and applications of a mobile device. In one embodiment, a mobile device may comprise an interface to establish a connection to a terminal and one or more browser based applications to be run locally on the mobile device. The mobile device may serve a browser based user interface to a browser of the terminal via the connection for interacting with the applications on the mobile device. Other embodiments are described and claimed.

### RELATED APPLICATIONS

This application claims priority to U.S. Provisional Patent Application Ser. No. 60/909,719, which was filed on Apr. 3, 2007. This application is also related and claims priority to U.S. patent application Ser. No. 11/612,282 titled “System for Running Web Applications Offline and Providing Access to Native Services,” which was filed on Dec. 18, 2006. These applications are entirely incorporated by reference.

### BACKGROUND

Several solutions exist for synchronizing a mobile device with a computer. For example, synchronization programs may allow a mobile device to transfer files from a desktop personal computer (PC) to the mobile device as well as to perform file and calendar synchronization. Client-server e-mail solutions “push” e-mail messages from dedicated servers to mobile devices equipped with appropriate software such that e-mail messaging seems “live.” Proprietary mobile phone tools software is a special computer based client that must be downloaded and installed on a PC to allow the user to connect a cellular telephone to the PC.

Existing synchronization solutions generally focus on moving data back and forth and require the installation and management of multiple pieces of software residing on the mobile device as well as on the PC or server. Users often experience difficulty when managing such software even when setting up basic functionality such as contacts and e-mail. In addition, such software requires users to perform tasks with their own computers and prevents the use of “guest” computers. Other frequent problems encountered by users with existing solutions include incorrectly setting up synchronization preventing e-mail receipt or data transfer, synchronizing in the wrong direction causing the destruction or loss of valuable data, and duplicating records needlessly resulting in redundant entries.

### BRIEF DESCRIPTION OF THE DRAWINGS

FIG. 1 illustrates one embodiment of a communications system.

FIG. 2 illustrates one embodiment of a communications system.

FIG. 3 illustrates one embodiment of a communications system.

FIG. 4 illustrates one embodiment of a communications system.

FIG. 5 illustrates one embodiment of a logic flow.

### DETAILED DESCRIPTION

Various embodiments are directed to providing a terminal with access to a desktop and applications of a mobile device. Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

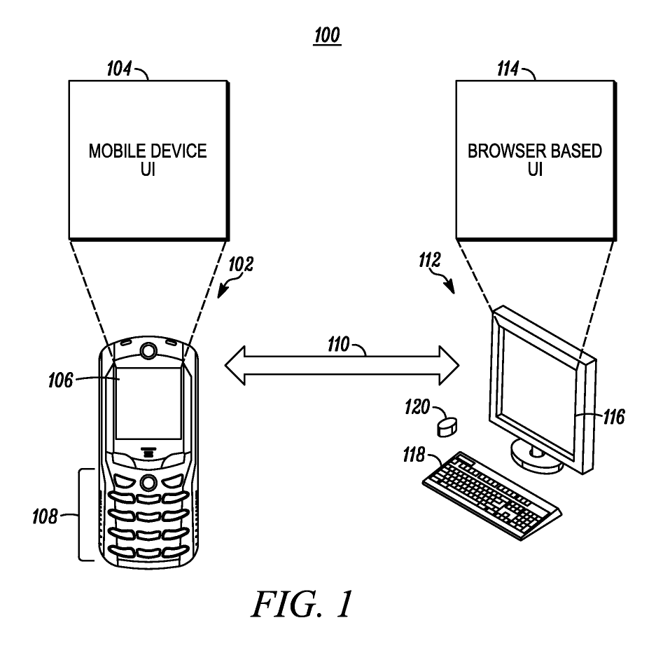

FIG. 1 illustrates a communications system 100 suitable for implementing various embodiments. Although FIG. 1 depicts a limited number of elements for purposes of illustration, it can be appreciated that the communications system 100 may include more or less elements as well as other types of elements in accordance with the described embodiments. Elements of the communications system 100 may comprise physical or logical entities for communicating information implemented as hardware components (e.g., computing devices, processors, logic devices), executable computer program instructions (e.g., firmware, software) to be executed by various hardware components, or combination thereof, as desired for a given set of design parameters or performance constraints.

As shown, the communications system 100 may comprise a mobile device 102. In some embodiments, the mobile device 102 may be implemented as a combination handheld computer and mobile telephone, sometimes referred to as a smart phone. It can be appreciated that while certain embodiments may be described with the mobile device 102 implemented as a smart phone by way of example, the mobile device 102 may be implemented as other types of user equipment (UE) or wireless computing devices such as a mobile telephone, personal digital assistant (PDA), combination mobile telephone/PDA, handheld device, mobile unit, subscriber station, game device, messaging device, media player, pager, or other suitable mobile communications devices.

The mobile device 102 generally may be configured to support or provide cellular voice communication, wireless data communication, and computing capabilities in accordance with the described embodiments. The mobile device 102 may comprise various components for providing such capabilities including, for example, a printed circuit board (PCB), one or more processors (e.g., host processor, radio processor), one or more transceivers (e.g., voice communications transceiver, data communications transceiver, GPS transceiver), memory (e.g., volatile or non-volatile memory, removable or non-removable memory, erasable or non-erasable memory, writeable or re-writeable memory), internal and/or external antennas, a rechargeable battery, and others.

The mobile device 102 may provide voice and wireless data communications functionality by communicating with a mobile network such as a Code Division Multiple Access (CDMA) network, Global System for Mobile Communications (GSM) network, North American Digital Cellular (NADC) network, Time Division Multiple Access (TDMA) network, Extended-TDMA (E-TDMA) network, Narrowband Advanced Mobile Phone Service (NAMPS) network, third generation (3G) network such as a Wide-band CDMA (WCDMA) network, CDMA-2000 network, Universal Mobile Telephone System (UMTS) network, and others.

The mobile device 102 also may support wireless wide area network (WWAN) data communications services including Internet access. Examples of WWAN data communications services may include Evolution-Data Optimized or Evolution-Data only (EV-DO), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

The mobile device 102 may provide wireless local area network (WLAN) data communications functionality in accordance with the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and others.

The mobile device 102 also may be arranged to perform data communications functionality in accordance with shorter range wireless networks, such as a wireless personal area network (PAN) offering Bluetooth® data communications services in accordance with the Bluetooth® Special Interest Group (SIG) series of protocols, specifications, profiles, and so forth. Other examples of shorter range wireless networks may employ infrared (IR) techniques or near-field communication techniques and protocols, such as electromagnetic induction (EMI) techniques including passive or active radio-frequency identification (RFID) protocols and devices.

The mobile device 102 may comprise various software programs such as system programs and applications to provide computing capabilities in accordance with the described embodiments. Exemplary system programs may include, without limitation, an operating system (OS), device drivers, programming tools, utility programs, software libraries, application programming interfaces (APIs), and so forth. Exemplary operating systems may include, for example, a Palm OS®, Microsoft® OS, Unix® OS, Linux® OS, Symbian OS™, Embedix OS, Binary Run-time Environment for Wireless (BREW) OS, JavaOS, a Wireless Application Protocol (WAP) OS, and others.

The mobile device 102 may provide a variety of applications for allowing a user to accomplish one or more specific tasks. Exemplary applications may include, without limitation, a web browser application (e.g., Internet Explorer®, Mozilla®, Firefox®, Safari®, Opera®, Netscape Navigator®), telephone application (e.g., cellular, VoIP, PTT), networking application, messaging application (e.g., e-mail, IM, SMS, MMS), contacts application, calendar application, word processing application, spreadsheet application, database application, media application (e.g., video player, audio player, multimedia player, digital camera, video camera, media management), location based services (LBS) application, gaming application, and so forth.

The applications may comprise or be implemented as executable computer program instructions stored on computer-readable storage media such as volatile or non-volatile memory capable of being retrieved and executed by a processor to provide operations for the mobile device 102. The memory also may implement various databases and/or other types of data structures (e.g., arrays, files, tables, records) for storing data for use by the processor and/or other elements of the mobile device 102.

In various implementations, an application may provide a user interface (UI) 104 to communicate information between the mobile device 102 and a user. The mobile device 102 may comprise various components or devices for interacting with the application such as a display 106 for presenting the UI 104 and a keypad 108 for inputting data and/or commands. The mobile device 102 may comprise other components or devices for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, a camera, and so forth.

As shown, a connection 110 may be established between the mobile device 102 and a terminal 112. In various embodiments, the mobile device 102 may comprise one or more input/output (I/O) interfaces for establishing the connection 110 with the terminal 112. The I/O interfaces may comprise, for example, a serial connection port, an IR port, a Bluetooth®interface, a network interface, a WiFi interface, a WiMax interface, a cellular network interface, a wireless network interface card (WNIC), a transceiver, and so forth.

The connection 110 may be implemented using various wired and/or wireless communication media in accordance with the described embodiments. Although certain exemplary embodiments may be described as using a particular communication media by way of example, it may be appreciated that the principles and techniques discussed herein may be implemented using various communication media and accompanying technology.

In some implementations, the connection 110 may comprise a wired connection such as a Universal Serial Bus (USB) connection (e.g., USB host, USB net), Serial Bus Interface (SBI) connection (e.g., FireWire®), or other suitable wired connection to directly connect (e.g., tether, plug in) the mobile device 102 to the terminal 112 when in close proximity. In other implementations, the connection 110 may comprise a short range wireless connection (e.g., Bluetooth®connection, IR connection) to communicatively couple the mobile device 102 to the terminal 112 when in close proximity. In some implementations, the connection 110 may comprise a network connection between the mobile device 110 and the terminal 112 such as a WiFi connection, WiMax connection, Ethernet connection, cellular network (e.g., 1G/2G/3G) connection, or other suitable packet data or switched connection in accordance with the described embodiments.

In some embodiments, the terminal 112 may comprise a local computing device such as a PC (e.g., desktop PC, laptop PC) or computing kiosk in close proximity to the mobile device 102. In other embodiments, the terminal 112 may comprise a computing device located remotely from the mobile device 102. In some implementations, the terminal 112 may be associated with the user such as the home or work PC of the user. In other implementations, the terminal 112 may be a guest or public computing device which is not associated with the user. In some cases, the terminal 112 may be operated by the user of the mobile device 102. In other cases, the terminal 112 may be operated by a third party such as a help center of a carrier to allow the carrier to remotely configure and/or fix problems encountered on the mobile device 102. Although the terminal 112 is shown as a PC for purposes of illustration, it can be appreciated that the terminal may be implemented by any suitable type of computing device in accordance with the described embodiments.

When the connection 110 is established, the mobile device 102 may be arranged to provide a portable application environment which can drive the terminal 112 so that applications on the mobile device 102 may be accessed by and used from the terminal 112. The portable application environment provided by the mobile device 102 may allow the terminal 112 to achieve the same functionality provided by one or more applications of the mobile device 102 without the need to install any additional software on the terminal 112 related to such applications. When connected to the terminal 112 via a USB connection, for example, the mobile device 102 may act as a virtual pluggable pocket computer in desktop PC and kiosk environments. When detached or disconnected from the terminal 112, the mobile device 102 may function or resume its role as a standalone mobile device.

In various embodiments, the desktop and/or one or more applications of the mobile device 102 may be accessed from a web browser (e.g., Internet Explorer®, Mozilla®, Firefox®, Safari®, Opera®, Netscape Navigator®) on the terminal 112. Using the web browser of the terminal 112, a user may navigate or “surf” to an Internet Protocol (IP) address or other suitable network address of the mobile device 102. When connected, the terminal 112 and the mobile device 102 may establish a client/server relationship in which the terminal 112 acts as the client and requests services from the mobile device 102 acting as the server. Accordingly, the web browser of the terminal 112 may be served up applications hosted by the mobile device 102.

In various embodiments, one or more applications hosted by the mobile device 102 may be implemented as browser-based applications comprising scripted programming language. Exemplary browser-based applications may comprise Basic, Java, and other web applications running scripting languages such as JavaScript, ECMAScript, VBScript, Adobe Macromedia Flash, Java, or other suitable scripted programming language in accordance with the described embodiments. It can be appreciated that in such embodiments, the applications hosted by the mobile device 102 may be authored using the same paradigm that is used to author web sites. Accordingly, the applications on the mobile device 102 may be configured to be accessed by a web browser running on the terminal 112 as well as a web browser running locally on the mobile device 102.

To provide server functionality, the mobile device 102 may comprise a local web host configured to serve local applications to a web browser. In various embodiments, the local web host may be implemented as Hypertext Transfer Protocol (HTTP) server and proxy logic running locally on the mobile device 102. The local web host may comprise and/or implement a server-side web services stack. In such embodiments, the mobile device 102 may be configured to act as an Internet server for enabling communication over an HTTP path to a web browser running on the terminal 112 via the connection 110.

The local web host may serve an application to a web browser from a web archive comprising a collection of the necessary application files for a web application. The web archive file may comprise a bundle or package of the web assets of the web application including index files, HTML files, script files (e.g., JavaScript or server script such as PHP, Python or Perl), graphics (e.g., JPEGs, GIFs), animations, directories, and other web application components. The web archive can be packaged, stored, and compressed using file archiving libraries such as zip, gzip or zlib, or other suitable packing schemes. In various embodiments, the local web host may be implemented as a Web Virtual Machine (VM), and the web archive may be generated as described in U.S. patent application Ser. No. 11/612,282 titled “System for Running Web Applications Offline and Providing Access to Native Services,” which was filed on Dec. 18, 2006 and is entirely incorporated by reference.

When implemented as a server on the mobile device 102, the local web host may support and provide access to multiple applications on the mobile device 102. The local web server may run server side code such as PHP, Python, PERL or CGI programming environments locally on the mobile device 102. The local web server also may implement web methods programming interfaces and web services extensions via SOAP, XML RPC, REST, and the like for enabling access to local resources of the mobile device 102. Accordingly, the mobile device 102 may provide server side interfaces to access local resources such as a file system, a phonebook, a media store, a database, a hardware component (e.g., camera, microphone, etc.), a software component, and/or other controlled resource of the mobile device 102. Such interfaces also may implement server side code for allowing the user to write to a local resource such as a phonebook, media store, and so forth.

In various embodiments, the mobile device 102 may implement security measures such as secure HTTP (https) and/or other login methods to obtain user authentication for preventing unauthorized access and use of the applications and/or other resources on the mobile device 102 from the terminal 112. The local web host may be configured to intermediate between the applications on the mobile device 102 and a web browser to broker local services and ensure that only a trusted entity is given access to specific functionality. The local web host also may implement various web based security models and access restrictions for evaluating function calls from a web browser which request access to local resources of the mobile device 102.

When connected to the terminal 112, the mobile device 102 may serve up a UI 114 to the terminal 112 for interacting with the desktop and/or applications of the mobile device 102. The UI 114 may run on the terminal 112 and provide access to the functionality of the mobile device 102 without installing any software on the terminal 112. In various embodiments, the UI 114 may comprise a browser-based UI served by the mobile device 102 and viewed within a web browser of the terminal 112. The web browser running on the terminal 112 may present the UI 114 in response to content received from the mobile device 102 over an HTTP path via the connection 110. The terminal 112 may act as a client using its Internet browser as the UI 114 for using the applications on the mobile device 102 without the need to install software. The mobile device 102 may act as a server (e.g., Internet server, HTTP server) and locally run the applications and respond to service requests from the browser on the terminal 112.

At the terminal 112, a user may view the UI 114 on a display 116 and interact with one or more applications of the mobile device 102 by inputting data and/or commands using devices or components such as a keyboard 118 and a mouse 120. The key strokes and clicks of the user at the terminal 112 may be sent to and interpreted by the mobile device 102 as key press events for interacting with the desktop, applications, and/or other resources of the mobile device 102.

It can be appreciated that the mobile device 102 may comprise a device having a handheld form factor. As such, the display 106, the keypad 108, and other assets (e.g., memory, browser) of the mobile device 102 may be smaller and more limited as compared to the assets of the terminal 112. The terminal 112 allows enhanced use of the applications on the mobile device 102 by taking advantage of the larger and/or more useful assets of the terminal 112 such as a larger screen 116, a full-size keyboard 118, a mouse 120, memory, browser plugins (e.g., Macromedia/Adobe Flash), hardware devices, and so forth.

The user may employ the terminal 112 in various ways for interacting with the applications on the mobile device 102 in a more efficient manner. For example, data can be stored and updated on the mobile device 102 more efficiently when using the terminal 112 than when using the limited key set of the mobile device 102. In addition, data can be stored directly to the mobile device 102 by using the browser of the terminal 112 to upload files from the terminal 112 directly in to the mobile device 102. In various implementations, software may be installed on the mobile device 102 more easily by using the terminal 112. For example, the mobile device 102 may support the ability to drag and drop applications, and the user may install software on the mobile device 102 by uploading and/or dragging and dropping applications using the browser on the terminal 112.

The user may configure the device 102 using the terminal 112 from a local or remote location. The user also may locally or remotely configure various resources on the mobile device 102 such as the phonebook or media store. In various embodiments, the mobile device 102 may support remote access and control by the user or a trusted entity via a “GoTo MyPhone” feature for providing network access to the desktop, applications, and/or other resources of the mobile device 102.

In some implementations, the UI 104 of the mobile device 102 may displayed remotely and identically within the UI 114 on the terminal 112. For example, the mobile device 102 may export its UI 104 to a carrier help center to allow the carrier to fix a problem encounter by the user. In such implementations, the UI 114 and key presses at the terminal 114 may exactly mirror the UI 104 and key presses of the mobile device 102 to allow problem diagnosis and correction. The carrier help center may connect to the mobile device 102 over a network (e.g., 3G network) and remotely control and/or help set up the mobile device 102.

The mobile device 102 also may provide data collection and access. Rather than sending data to a specified destination, the mobile device 102 acts as collector and Internet server for allowing access and retrieval of information. For example, the mobile device 102 may serve statistics such as the battery level, current memory capacity, files loaded on the mobile device 102, and so forth to the terminal 112. In such cases, the mobile device 102 may act as a server and allow a user at the terminal 112 to log in and retrieve such information from a remote location.

The mobile device 102 also may support remote control in various other ways. For example, the mobile device 102 may be used for remote monitoring applications. In some embodiments, the mobile device 102 may implement a digital I/O connected via Serial Peripheral Interface Bus (SPI) and/or IR to function as useful remote monitoring box. In some cases, the mobile device 102 may be used in security applications such as by implementing a remote controlled camera and/or remote controlled listening capability.

In some embodiments, the UI 114 displayed by the terminal 112 may show an exact copy of the user interface 104 of the mobile device 102. In such embodiments, the browser of the terminal 112 may depict the browser based applications of the mobile device 102 in the same way as they appear and are run on by the browser of the mobile device 102. In some cases, the UI 104 of the mobile device 102 and the UI 114 of the terminal 112 may be presented at the same time. Accordingly, the UI 114 displayed by the terminal 112 may provide a supplemental user interface for the user showing the UI 104 of the mobile device 102.

In various implementations, the mobile device 102 may support partial updating of the UI 114 on the terminal. For example, the whole screen on the mobile device 102 may be served up to the terminal 112 as tiles or blocks. The underlying data for the tiles or block may correspond to regions of the screen of the mobile computing device 102. As the underlying data changes, the UI 114 can be partially updated by updating only those tiles or blocks which change.

In some embodiments, applications on the mobile device 102 may be configured to run in different modes. In such embodiments, an application may be configured to detect the environment for running the application and adapt the UI 114 for display by the terminal 112. For example, the application may implement script or hosting knowledge for realizing that the UI 114 is running on the terminal 112. Accordingly, the application may detect the environment and self-adjust to the screen size of the display 116 for the terminal 112.

In various implementations, the UI 114 displayed by the terminal 112 may comprise an enhanced interface as compared to the UI 104 the mobile device 102. For example, an application on the mobile device 102 may be configured to serve up a UI 104 comprising a phone-centric interface to the browser of the mobile device 102 and configured to serve up a UI 114 comprising an enhanced (e.g., larger/better/different) interface when connected to the browser of the terminal 112. In general, an application may serve a simplified interface to display on the mobile device 102 and an enhanced interface to take advantage of the larger and/or more useful assets (e.g., larger screen 116, a full-size keyboard 118, a mouse 120, memory, browser plugins, hardware, etc.) of the terminal 112. For instance, an application on the mobile device 102 which uses 4-way navigation and 2 soft keys when in a phone mode may serve an enhanced UI 114 to the terminal 112 that can use navigation hardware such as the full keyboard 118 and mouse 120 and that displays more content in the larger screen 116 of the terminal 112.

In some embodiments, the use of web based technologies may allow the mobile device 102 to deliver rich data applications such as small widgets or even conventional larger application. In some cases, for example, the mobile device 102 may be configured to host and run PC applications. In such cases, an enhanced version of the application may be run when accessed by the terminal 112 while a simpler version of the application runs when accessed by the mobile device 102. The application may be configured to support both environments without requiring modification of the application in the process. As such the application may detect its environment and run differently when used by the mobile device 102 and when used by the terminal 112.

Further exemplary embodiments are discussed below in which like reference numerals refer to similar elements as described above. It can be appreciated that any of the features, structures or characteristics described in the context of a particular embodiment are not limited to such embodiment and are not intended to suggest any limitation as to the scope of use or functionality of such embodiment.

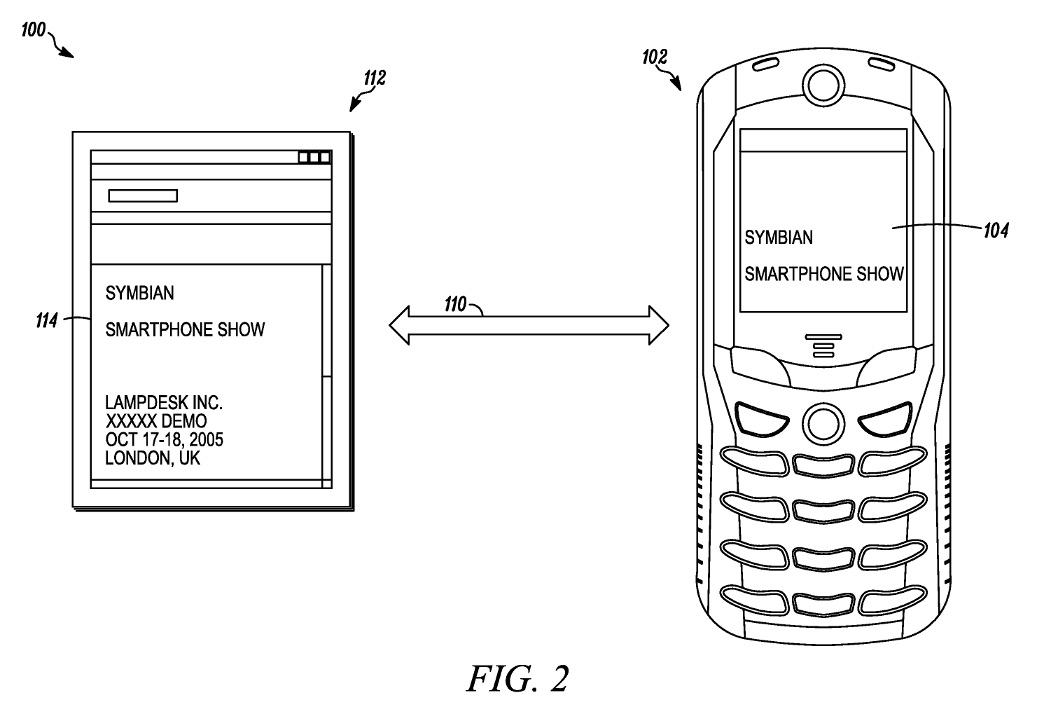

FIG. 2 illustrates one embodiment of a communications system 100 comprising a mobile device 102 displaying a UI 104 and communicating via a connection 110 (e.g., Bluetooth®connection, IR connection) with a terminal 112. As shown, the terminal 112 may display an enhanced browser based UI 114. In this embodiment, the application on the mobile device 102 may detect the environment for the application and self-adjust the UI 114 served to terminal 112 for display on a larger screen. The UI 114 may provide more content and/or additional functionality as compared to the UI 104.

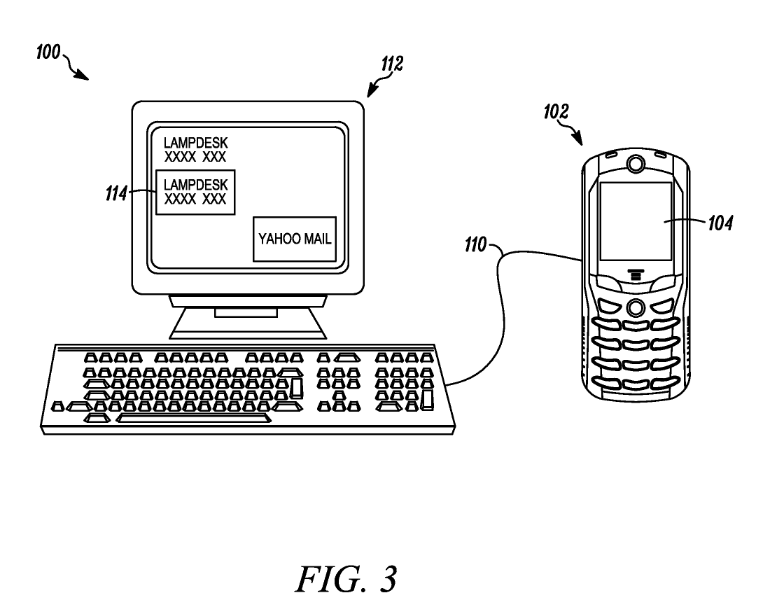

FIG. 3 illustrates one embodiment of a communications system 100 comprising a mobile device 102 displaying a UI 104 and communicating via a connection 110 (e.g., tethered USB connection) with a terminal 112. As shown, the terminal 112 may display an enhanced browser based UI 114. In this embodiment, the UI 114 may comprise multiple views (e.g., frames, windows) corresponding to multiple applications hosted by the mobile device 102. The mobile device 102 may be configured to serve multiple applications to the terminal 112 at the same time allowing the user to interact with multiple simultaneous applications via the UI 114 and assets of the terminal 112.

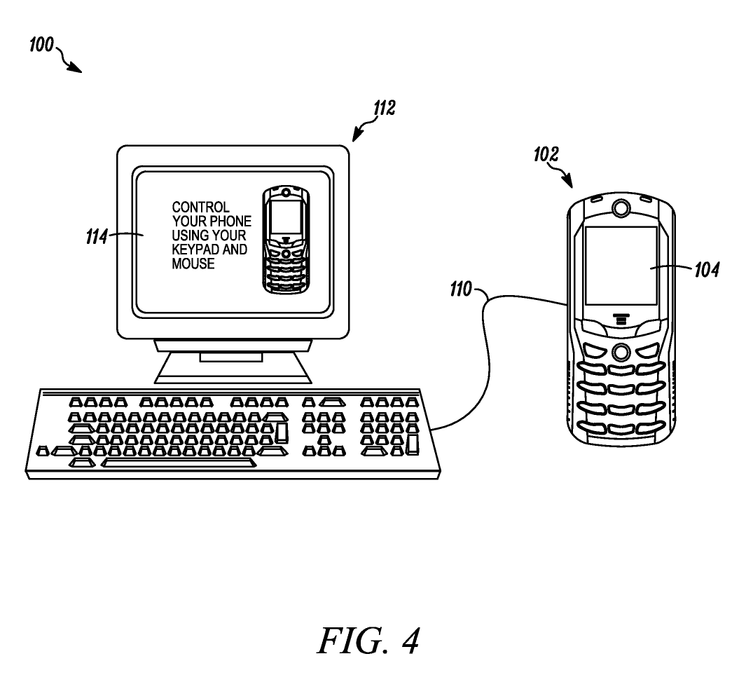

FIG. 4 illustrates one embodiment of a communications system 100 comprising a mobile device 102 displaying a UI 104 and communicating via a connection 110 (e.g., tethered USB connection) with a terminal 112. As shown, the terminal 112 may display an enhanced browser based UI 114. In this embodiment, the UI 114 may comprise a “virtual phone” or emulator that may look similar and/or identical to the mobile device 102. The user may input clicks on the keypad of the virtual phone via the UI 114 which are sent as key press events to the actual mobile device 102.

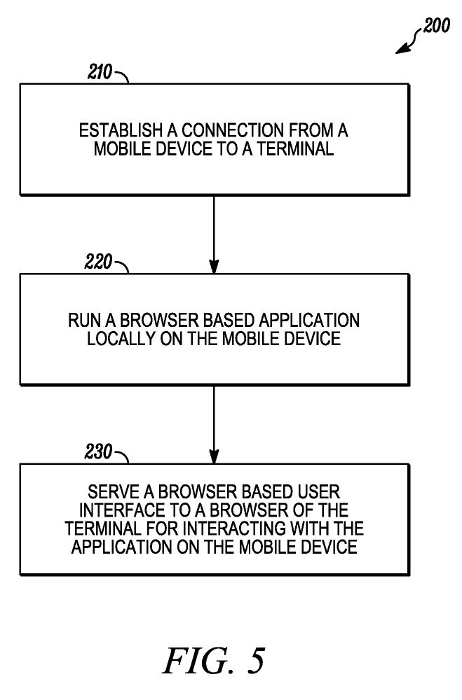

FIG. 5 illustrates one embodiment of a logic diagram 200, which may be representative of the operations executed by one or more embodiments described herein. In this embodiment, the logic diagram 200 may comprise establishing a connection from a mobile device to a terminal (block 210), running a browser based application locally on the mobile device (block 220), and serving a browser based user interface to a browser of the terminal via the connection for interacting with the application on the mobile device (block 230). It can be appreciated that the logic diagram 200 may comprise various other operations in accordance with the described embodiments.

In various embodiments, the logic diagram 200 may comprise, or be implemented as, executable computer program instructions. The executable computer program instructions may be implemented by software, firmware, a module, an application, a program, a widget, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

In various embodiments, the logic diagram 200 may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments. In such embodiments, a computer may include any suitable computer platform, device, system, or the like implemented using any suitable combination of hardware and/or software.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage media in accordance with the described embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A mobile device comprising:
an interface to establish a connection to a terminal; and
at least one browser based application to be run locally on the mobile device and to serve a browser based user interface to a browser of the terminal via the connection for interacting with the application on the mobile device.

2. The mobile device of claim 1, wherein the connection comprise at least one of a wired serial connection, a short range wireless connection, and a network connection.

3. The mobile device of claim 1, wherein the terminal comprises at least one of a personal computer and a kiosk.

4. The mobile device of claim 1, wherein the mobile device provides a portable application environment to drive the terminal for allowing the application to be accessed by and used from the terminal without installing additional software on the terminal related to the application.

5. The mobile device of claim 1, wherein the terminal and the mobile device establish a client/server relationship in which the terminal acts as the client and the mobile device acts as the server.

6. The mobile device of claim 1, wherein the browser navigates to a network address of the mobile device.

7. The mobile device of claim 1, wherein the application comprises a scripted programming language.

8. The mobile device of claim 1, wherein the mobile device comprise a local web host to serve the application to the browser of the terminal.

9. The mobile device of claim 8, wherein the local web host comprises a web services stack.

10. The mobile device of claim 1, wherein the mobile device provides the terminal with access to a local resource of the mobile device.

11. The mobile device of claim 1, wherein the mobile device allows the terminal to write to the local resource.

12. The mobile device of claim 1, wherein the mobile device requests authorization from the terminal.

13. The mobile device of claim 1, wherein the mobile device comprise a display and a keypad and the terminal comprises a larger display, a keyboard, and a mouse for interacting with the application.

14. The mobile device of claim 13, wherein key strokes and clicks of a user at the terminal are sent to and interpreted by the mobile device as key press events for interacting with the mobile device.

15. The mobile device of claim 1, wherein the terminal stores data on the mobile device.

16. The mobile device of claim 1, wherein the terminal installs software on the mobile device.

17. The mobile device of claim 16, wherein the mobile device supports dragging and dropping software on the mobile device using the browser on the terminal.

18. The mobile device of claim 1, wherein the terminal configures the mobile device.

19. The mobile device of claim 1, wherein the terminal remotely accesses the mobile device.

20. The mobile device of claim 1, wherein the terminal retrieves statistics associated with the mobile device.

21. The mobile device of claim 1, wherein the terminal remotely controls the mobile device.

22. The mobile device of claim 1, wherein the user interface comprises an exact copy of a user interface displayed when the application is accessed by the mobile device.

23. The mobile device of claim 1, wherein the mobile device supports partial updating of the user interface on the terminal.

24. The mobile device of claim 1, wherein the application supports multiple environments and the mobile device runs an enhanced version of the application when accessed by the terminal and a simpler version of the application when accessed by the mobile device.

25. The mobile device of claim 1, wherein the application detects an environment for running the application and adapts the user interface for display by the terminal.

26. The mobile device of claim 25, wherein the application self-adjusts the size of the user interface for display by the terminal.

27. The mobile device of claim 25, wherein the user interface comprises an enhanced user interface as compared to a user interface presented when accessed by the mobile device.

28. The mobile device of claim 27, wherein the enhanced user interface provides more content than the user interface presented when accessed by the mobile device.

29. The mobile device of claim 27, wherein the enhanced user interface provides more functionality than the user interface presented when accessed by the mobile device.

30. The mobile device of claim 27, wherein the user interface comprises multiple views corresponding to multiple applications hosted by the mobile device.

31. The mobile device of claim 27, wherein the user interface depicts an emulator comprising a virtual mobile device and inputs to the virtual mobile device are sent as key press events to the mobile device.

32. A method comprising:
establishing a connection from a mobile device to a terminal;
running a browser based application locally on the mobile device; and
serving a browser based user interface to a browser of the terminal via the connection for interacting with the application on the mobile device.

33. A computer-readable storage medium comprising executable computer program instructions that when executed enable a computing system to:
establish a connection from a mobile device to a terminal;
run a browser based application locally on the mobile device; and
serve a browser based user interface to a browser of the terminal via the connection for interacting with the application on the mobile device.
